(19) United States
(12) Patent Application Publication
(10) Pub. No.: US 2022/0043129 A1
(43) Pub. Date: Feb. 10, 2022

(54) TIME FLIGHT DEPTH CAMERA AND MULTI-FREQUENCY MODULATION AND DEMODULATION DISTANCE MEASURING METHOD

(71) Applicant: ORBBEC INC., Shenzhen (CN)

(72) Inventors: Xiaolong HU, SHENZHEN (CN); Liang ZHU, SHENZHEN (CN)

(21) Appl. No.: 17/506,009

(22) Filed: Oct. 20, 2021

Related U.S. Application Data
(63) Continuation of application No. PCT/CN2019/086294, filed on May 9, 2019.

(51) Int. Cl. G01S 7/4865; G01S 17/10

(52) U.S. Cl. CPC G01S 7/4865; G01S 17/10

(57) ABSTRACT

A time flight depth camera and a distance measuring method are provided. The time flight depth camera comprises: a light source for emitting a pulse beam to an object; an image sensor comprising at least one pixel, wherein each of the at least one pixel comprises taps, and each tap is used for acquiring a charge signal based on a reflected pulse beam due to the pulse beam reflected from the object to be measured or a charge signal of background light; and a processing circuit configured to control the light source to emit pulse beams in adjacent frame periods, receive charge signals of the taps in the adjacent frame periods, determine whether the charge signals comprise the charge signal of the reflected pulse beam, and calculate a time of flight of the pulse beam and/or a distance to the object according to a result of the determining.

### CROSS-REFERENCE TO RELATED APPLICATIONS

This is a continuation of International Patent Application No. PCT/CN2019/086294, filed on May 9, 2019. The entire content of the above-identified applications is incorporated herein by reference.

### TECHNICAL FIELD

This application relates to the field of optical measurement, and in particular, to a time-of-flight depth camera and a multi-frequency modulation and demodulation distance measurement method.

### BACKGROUND

A full name of TOF is Time-of-Flight, namely, a time of flight. A TOF distance measurement method is a technology that implements accurate distance measurement by measuring a round-trip time of flight of a light pulse between a transmission/receiving apparatus and a target object. In the TOF technology, a technology for directly measuring a time of flight of light is referred to as direct-TOF (dTOF). A measurement technology for periodically modulating a transmitted optical signal, measuring a phase delay of a reflected optical signal relative to the transmitted optical signal, and then calculating a time of flight according to the phase delay is referred to as an indirect-TOF (iTOF) technology. Different types of modulation and demodulation manners may be divided into a continuous wave (CW) modulation and demodulation manner and a pulse modulated (PM) modulation and demodulation manner.

Currently, the CW-iTOF technology is mainly applicable to a measurement system constructed based on a two-tap sensor, and a core measurement algorithm is a four-phase modulation and demodulation manner, where at least two exposures are needed (to ensure the measurement precision, four exposures may be needed) for acquisition of four-phase data to output one frame of a depth image. As a result, it is difficult to obtain a relatively high frame frequency. The PM-iTOF modulation technology is mainly applicable to a four-tap sensor (three taps are used for acquisition and output of signals, and one tap is used for releasing invalid electrons). A measurement distance of this measurement manner is currently limited by a pulse width of a modulation and demodulation signal. When a long distance measurement needs to be performed, the pulse width of the modulation and demodulation signal needs to be extended, but the extension of the pulse width of the modulation and demodulation signal may increase power consumption and decrease measurement precision, which cannot meet a market requirement consequently. For disadvantages of these current two modulation and demodulation manners, a new modulation and demodulation manner is provided herein to optimize the iTOF technical solution.

### SUMMARY

To resolve the existing problems, this application provides a time-of-flight depth camera and a multi-frequency modulation and demodulation distance measurement method.

To resolve the above problems, the technical solutions adopted by this application are as follows.

A time-of-flight depth camera is provided, which comprises: a light source for emitting a pulse beam to an object to be measured; an image sensor comprising at least one pixel, wherein each of the at least one pixel comprises a plurality of taps, and each of the plurality of taps is used for acquiring a charge signal based on a reflected pulse beam due to the pulse beam reflected from the object to be measured or a charge signal of background light; and a processing circuit configured to control the light source to emit pulse beams of different frequencies in adjacent frame periods, receive charge signals of the plurality of taps in the adjacent frame periods respectively, determine whether the charge signals comprise the charge signal of the reflected pulse beam, and calculate a time of flight of the pulse beam and/or a distance to the object to be measured according to a result of the determining.

In an embodiment, the processing circuit calculates the time of flight of the pulse beam according to the following formula:

$$t = ( \frac{Q B - Q O}{Q A + Q B - 2 Q O} + m ) T h + j \cdot Tp$$

wherein, after the determining, QA is a charge quantity comprising the charge signal of the reflected pulse beam and acquired by a first one of the plurality of taps; QB is a charge quantity comprising the charge signal of the reflected pulse beam and acquired by a second one of the plurality of taps; QO is a charge quantity comprising the charge signal of the background light and acquired by the plurality of taps; m=n−1, wherein n refers to a serial number of a tap corresponding to the QA; j refers to that the reflected pulse beam is first acquired by a tap in a j^{th} pulse period after the pulse beam is emitted; Th is a pulse width of a pulse acquisition signal of each tap; and Tp is a pulse period.

In an embodiment, the determining comprises a single-tap maximization method, to obtain a first tap with a maximum charge quantity of charge signals in the plurality of taps, and if a charge quantity of charge signals of a second tap before the first tap is greater than a charge quantity of charge signals of a third tap after the first tap, the charge quantity of charge signals acquired by the second tap is the QA and a charge quantity of charge signals acquired by the first tap is the QB; and if the charge quantity of the charge signals of the second tap before the first tap is less than the charge quantity of the charge signals of the third tap after the first tap, the charge quantity of the charge signals acquired by the first tap is the QA and the charge quantity of the charge signals of the third tap is the QB; or the determining comprises an adjacent-tap-sum maximization method, to obtain a maximum sum of charge quantity of charge signals after calculating a charge quantity of charge signals of adjacent taps, wherein charge quantities of charge signals acquired by two taps corresponding to the maximum sum are respectively the QA and the QB according to a serial number sequence of the two taps.

In an embodiment, a value of j is obtained (i) according to a remainder theorem or (ii) by traversing values of j corresponding to frame periods within a maximum measurement distance, and using a value of j with a minimum time of flight calculation variance as a solution value.

In an embodiment, the QO is obtained by at least one of the following manners: taking a charge quantity of charge signals acquired by a tap after a tap corresponding to the QB; taking a charge quantity of charge signals acquired by a tap before the tap corresponding to the QA; taking an average value of charge quantities of charge signals acquired by the plurality of taps excluding the tap corresponding to the QA and the tap corresponding to the QB; or taking an average value of charge quantities of charge signals acquired by the plurality of taps excluding the tap corresponding to the QA and the tap corresponding to the QB and a tap after the tap corresponding to the QB.

A distance measurement method is provided, which comprises: emitting, by a light source, a pulse beam to an object to be measured; acquiring, by an image sensor comprising at least one pixel, a charge signal based on a reflected pulse beam due to the pulse beam reflected from the object to be measured or a charge signal of background light, wherein each of the at least one pixel comprises a plurality of taps, and each of the plurality of taps is used for acquiring the charge signal; controlling the light source to emit pulse beams of different frequencies in adjacent frame periods, and receiving charge signals of the plurality of taps in the adjacent frame periods respectively; determining whether the charge signals comprise the charge signal of the reflected pulse beam; and calculating a time of flight of the pulse beam and/or a distance to the object to be measured according to a result of the determining.

In an embodiment, the time of flight is calculated according to the following formula:

$$t = ( \frac{Q B - Q O}{Q A + Q B - 2 Q O} + m ) T h + j \cdot Tp$$

wherein, after the determining, QA is a charge quantity comprising the charge signal of the reflected pulse beam and acquired by a first one of the plurality of taps; QB is a charge quantity comprising the charge signal of the reflected pulse beam and acquired by a second one of the plurality of taps; QO is a charge quantity only comprising the charge signal of the background light and acquired by the plurality of taps; m=n−1, wherein n refers to a serial number of a tap corresponding to the QA; j refers to that the reflected pulse beam is first acquired by a tap in a j^{th} pulse period after the pulse beam is emitted; Th is a pulse width of a pulse acquisition signal of each tap; and Tp is a pulse period.

In an embodiment, the determining comprises a single-tap maximization method, to obtain a first tap with a maximum charge quantity of charge signals in the plurality of taps, and if a charge quantity of charge signals of a second tap before the first tap is greater than a charge quantity of charge signals of a third tap after the first tap, the charge quantity of charge signals acquired by the second tap is QA and a charge quantity of charge signals acquired by the first tap is the QB; and if the charge quantity of the charge signals of the second tap before the first tap is less than the charge quantity of the charge signals of the third tap after the first tap, the charge quantity of the charge signals acquired by the first tap is the QA and the charge quantity of the charge signals of the third tap is the QB; or the determining comprises an adjacent-tap-sum maximization method, to obtain a maximum sum of charge quantity of charge signals after calculating a charge quantity of charge signals of adjacent taps sequentially, wherein charge quantities of charge signals acquired by two taps corresponding to the maximum sum are respectively the QA and the QB according to a serial number sequence of the two taps.

In an embodiment, a value of j is obtained (i) according to a remainder theorem or (ii) by traversing values of j corresponding to frame periods within a maximum measurement distance, and using a value of j with a minimum time of flight calculation variance as a solution value.

In an embodiment, the QO is obtained by at least one of the following manners: taking a charge quantity of charge signals acquired by a tap after a tap corresponding to the QB; taking a charge quantity of charge signals acquired by the tap before a tap corresponding to the QA; taking an average value of charge quantities of charge signals acquired by the plurality of taps excluding the tap corresponding to the QA and the tap corresponding to the QB; or taking an average value of charge quantities of charge signals acquired by the plurality of taps excluding the tap corresponding to the QA and the tap corresponding to the QB and a tap after the tap corresponding to the QB.

The beneficial effects of this application are: a time-of-flight depth camera and a multi-frequency modulation and demodulation distance measurement method are provided, to resolve a conflict in an existing PM-iTOF measurement solution that the pulse width is in direct proportion to a measurement distance and power consumption, but is negatively correlated with the measurement precision. Therefore, the extension of the measurement distance is no longer limited by the pulse width. In a case of a longer measurement distance, lower measurement power consumption and higher measurement precision may be still be retained.

### BRIEF DESCRIPTION OF THE DRAWINGS

FIG. 1 is a schematic diagram illustrating the principles of a time-of-flight depth camera, according to an embodiment of this application.

FIG. 2 is a schematic timing diagram of an optical signal transmission and acquisition method for a time-of-flight depth camera, according to an embodiment of this application.

FIG. 3 is a schematic timing diagram of optical signal transmission and acquisition for a time-of-flight depth camera, according to another embodiment of this application.

### DETAILED DESCRIPTION

To make the technical problems to be resolved by the embodiments of this application, and the technical solutions and beneficial effects of the embodiments of this application clearer and more comprehensible, the following further describes this application in detail with reference to the accompanying drawings and embodiments. It should be understood that the specific embodiments described herein are merely used for explaining this application but do not limit this application.

It should be noted that, when an element is described as being “fixed on” or “disposed on” another element, the element may be directly located on the another element, or indirectly located on the another element. When an element is described as being “connected to” another element, the element may be directly connected to the another element, or indirectly connected to the another element. In addition, the connection may be used for fixation or circuit connection.

It should be understood that orientation or position relationships indicated by terms such as “length,” “width,” “above,” “below,” “front,” “back,” “left,” “right,” “vertical,” “horizontal” “top,” “bottom,” “inside,” and “outside” are based on orientation or position relationships shown in the accompanying drawings, and are used only for ease and brevity of illustration and description of the embodiments of this application, rather than indicating or implying that the mentioned apparatus or element needs to have a particular orientation or needs to be constructed and operated in a particular orientation. Therefore, such terms should not be construed as limiting this application.

In addition, terms “first” and “second” are used merely for the purpose of description, and shall not be construed as indicating or implying relative importance or implying a quantity of indicated technical features. In view of this, a feature defined by “first” or “second” may explicitly or implicitly include one or more features. In the descriptions of the embodiments of this application, unless otherwise specified, “a plurality of” means two or more than two.

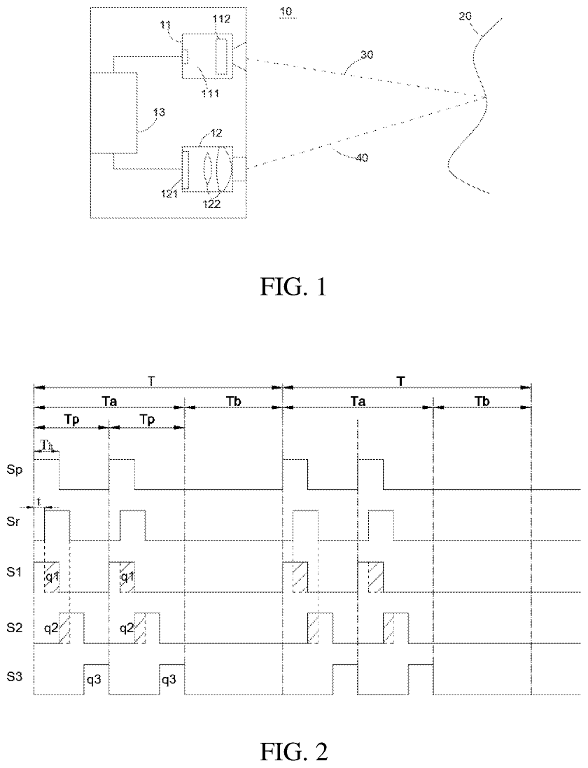

FIG. 1 is a schematic diagram of a time-of-flight depth camera, according to an embodiment of this application. The time-of-flight depth camera 10 includes an emitting module 11, an acquisition module 12, and a processing circuit 13. The emitting module 11 provides an emitted beam 30 to a target space to illuminate an object 20 in the space. At least a portion of the emitted beam 30 is reflected by the object 20 to form a reflected beam 40, and at least a portion of the reflected beam 40 is acquired by the acquisition module 12. The processing circuit 13 is respectively connected to the emitting module 11 and the acquisition module 12. Trigger signals of the emitting module 11 and the acquisition module 12 are synchronized to calculate a time required for the beam to be emitted by the emitting module 11 and received by the acquisition module 12, that is, a time of flight (TOF) t between the emitted beam 30 and the reflected beam 40. Further, a total light flight distance D to a corresponding point on the object can be calculated by the following formula:

D=c·t (1)

where c is a speed of light.

The emitting module 11 includes a light source 111, a beam modulator 112, and a light source driver (not shown in the figure). The light source 111 may be a light source such as a light emitting diode (LED), an edge emitting laser (EEL), or a vertical cavity surface emitting laser (VCSEL), or may be a light source array including a plurality of light sources. A beam emitted by the light source may be visible light, infrared light, ultraviolet light, or the like. The light source 111 emits a beam under the control of the light source driver (which may be further controlled by the processing circuit 13). For example, in an embodiment, the light source 111 is controlled to emit a pulse beam at a certain frequency, which can be used in a direct TOF measurement method, where the frequency is set according to a to-be-measured distance, for example, set to 1 MHz to 100 MHz. The to-be-measured distance may range from several meters to several hundred meters. In an embodiment, an amplitude of the beam emitted by the light source 111 is modulated so that the light source 111 emits a beam such as a pulse beam, a square wave beam, or a sine wave beam, which can be used in an indirect TOF measurement method. It may be understood that the light source 111 may be controlled to emit a beam by a portion of the processing circuit 13 or a sub-circuit independent of the processing circuit 13, such as a pulse signal generator.

The beam modulator 112 receives the beam from the light source 111, and emits a spatial modulated beam, for example, a flood beam with a uniform intensity distribution or a patterned beam with a nonuniform intensity distribution. It may be understood that, the uniform distribution herein is a relative concept rather than absolutely uniform. Generally, the beam intensity in an edge of a field of view (FOV) may be lower. In addition, the intensity in the middle of an imaging region may change within a certain threshold, for example, an intensity change not exceeding a value such as 15% or 10% may be permitted. In some embodiments, the beam modulator 112 is further configured to expand the received beam, to increase an FOV angle.

The acquisition module 12 includes an image sensor 121 and a lens unit 122, and may further include a light filter (not shown in the figure). The lens unit 122 receives at least a portion of the spatial modulated beam reflected by the object, and images the at least a portion of the spatial modulated beam on the image sensor 121. A narrow-band light filter matching a wavelength of the light source may be selected as the light filter to restrain background light noise of other wave bands. The image sensor 121 may include one or more of a charge coupled device (CCD), a complementary metal oxide semiconductor (CMOS), an avalanche diode (AD), a single-photon avalanche diode (SPAD), and the like. An array size of the image sensor 121 represents a resolution, such as 320×240, of the depth camera. Generally, a readout circuit (not shown in the figure) including one or more of devices such as a signal amplifier, a time-to-digital converter (TDC), and an analog-to-digital converter (ADC) is further connected to the image sensor 121.

Generally, the image sensor 121 includes at least one pixel, and each pixel includes a plurality of taps (which are used for storing and reading or releasing charge signals generated by incident photons under the control of a corresponding electrode). For example, three taps may be included for reading data of the charge signals.

In some embodiments, the time-of-flight depth camera 10 may further include devices such as a driving circuit, a power supply, a color camera, an infrared camera, and an inertial measurement unit (IMU), which are not shown in the figure. Combinations with such devices can achieve more abundant functions, such as 3D texture modeling, infrared face recognition, and simultaneous localization and mapping (SLAM). The time-of-flight depth camera 10 may be included in an electronic product such as a mobile phone, a tablet computer, or a computer.

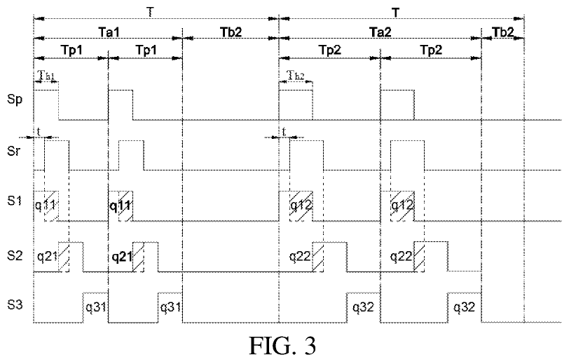

The processing circuit 13 may be an independent dedicated circuit, for example, a dedicated SOC chip, FPGA chip, or ASIC chip including a CPU, a memory, a bus, and the like, or may include a general processing circuit. For example, when the depth camera is integrated in a smart terminal such as a mobile phone, a television, or a computer, a processing circuit in the terminal may be used as at least a portion of the processing circuit 13. In some embodiments, the processing circuit 13 is configured to provide a modulation signal (transmission signal) required by the light source 111, and the light source emits a pulse beam to an object to be measured under the control of the modulation signal. In addition, the processing circuit 13 further provides a demodulation signal (acquisition signal) for taps in each pixel of the image sensor 121, and the taps acquire, under the control of the demodulation signal, charge signals generated by beams including a pulse beam reflected by the object to be measured. Generally, the beams may also include background light and disturbance light besides reflected pulse beam reflected by the object to be measured. The processing circuit 13 may further provide an auxiliary monitoring signal, such as a temperature sensing signal, an overcurrent or overvoltage protection signal, or a drop protection signal. The processing circuit 13 may be further configured to save original data acquired by the taps in the image sensor 121 and proceed accordingly, thereby obtaining specific position information of the object to be measured. The modulation and demodulation method and functions of control and processing that are executed by the processing circuit 13 will be described in detail in embodiments of FIG. 2 and FIG. 3. For ease of description, a PM-iTOF modulation and demodulation method is used as an example.

FIG. 2 is a schematic timing diagram of an optical signal transmission and acquisition method for a time-of-flight depth camera, according to an embodiment of this application. FIG. 2 shows a schematic diagram of a sequence of a laser transmission signal (modulation signal), a receiving signal, and an acquisition signal (demodulation signal) in two frame periods 2T. Sp represents pulse transmission signals of the light source, and each pulse transmission signal represents one pulse beam. Sr represents reflected optical signals reflected by an object. Each reflected optical signal represents a corresponding pulse beam reflected by the object to be measured, with a certain delay relative to the pulse transmission signal in a timeline (the horizontal axis in the figure), and a delayed time t is the time of flight of the pulse beam to be calculated. S1 represents pulse acquisition signals of a first tap in a pixel, S2 represents pulse acquisition signals of a second tap in the pixel, S3 represents pulse acquisition signals of a third tap in the pixel, and each pulse acquisition signal represents a charge signal (electrons) generated by the pixel in a time segment corresponding to the signal and acquired by the tap, and Tp=N×Th, where N is a quantity of taps participating in pixel electron acquisition.

The entire frame period T is divided into two time segments Ta and Tb, where Ta represents a time segment in which the taps of the pixel perform charge acquisition and storage, and Tb represents a time segment in which charge signals are read out. In the charge acquisition and storage time segment Ta, an acquisition signal pulse of an nth tap has a (n−1)×Th phase delay time with respect to a laser transmission signal pulse. When the reflected optical signal is reflected by the object to the pixel, each tap acquires electrons generated on the pixel within a corresponding pulse time segment of the pixel. In this embodiment, the acquisition signal and the laser transmission signal of the first tap are triggered synchronously. When the reflected optical signal is reflected by the object to the pixel, the first tap, the second tap, and the third tap respectively perform charge acquisition and storage, sequentially, to obtain charge quantities q1, q2, and q3, respectively, so as to complete a pulse period Tp, and Tp=3Th for a case of three taps. In the embodiment shown in FIG. 2, two pulse periods Tp are included in a single frame period, and a laser pulse signal is emitted twice in total. Therefore, a total charge quantity acquired and read out by the taps in the time segment Tb is a sum of charge quantities corresponding to optical signals acquired twice. It may be understood that, in a single frame period, a quantity of pulse periods Tp or a quantity of times that the laser pulse signal is emitted may be K, where K is not less than 1, or may be up to tens of thousands or even higher, and a specific quantity may be determined according to an actual requirement. In addition, quantities of pulses in different frame periods may also be different.

Therefore, the total charge quantity acquired and read out by the taps in the time segment Tb is a sum of charge quantities corresponding to optical signals acquired by the taps for a plurality of times in the entire frame period T. The total charge quantity of the taps in a single frame period may be represented as follows:

Qi=Σqi,i=1,2,3 (2)

According to formula (2), the total charge quantities of the first tap, the second tap, and the third tap in a single frame period are Q1, Q2, and Q3, respectively.

In a conventional modulation and demodulation manner, a measurement range is limited within a single-pulse-width time Th. That is, it is assumed that the reflected optical signal is acquired by the first tap and the second tap (the first tap and the second tap may also acquire an ambient light signal simultaneously), and the third tap is used for acquiring the ambient light signal. In this way, based on the total charge quantities acquired by the taps, a processing unit may calculate, according to the following formula, a total light flight distance of a pulse optical signal from being transmitted at the light source to being received at the pixel:

$$D = c T = c ( \frac{Q 2 - Q 3}{Q 1 + Q 2 - 2 Q 3} ) Th \qquad ( 3 )$$

Further, spatial coordinates of a target may be then calculated according to optical and structural parameters of the camera.

The conventional modulation and demodulation manner has an advantage of simple calculation, but a disadvantage of limited measurement range, where a measured TOF is limited within Th, and a corresponding maximum flight distance measurement range is limited within c×Th.

To increase a measurement distance, this application provides a new modulation and demodulation method. FIG. 2 is a schematic timing diagram of optical signal transmission and acquisition, according to an embodiment of this application. In this case, the reflected optical signal may not only fall onto the first tap and the second tap, but be also permitted to fall onto the second tap and the third tap, and may be even permitted to fall onto the third tap and a first tap in a next pulse period Tp (for a case that there are at least two pulse periods Tp). The “fall onto a tap” herein means that the signal may be acquired by the tap. The total charge quantities read within the time segment Tb are Q1, Q2, and Q3, and different from the conventional modulation and demodulation manner. In this application, taps for receiving the reflected optical signals and periods are not limited.

Considering that a charge quantity acquired by a tap receiving the reflected optical signal is greater than that acquired by a tap receiving only background light signals, the processing circuit evaluates the three obtained total charge quantities Q1, Q2, and Q3, to determine taps that acquire excitation electrons of the reflected optical signal and/or taps that acquire only background signals. In practice, interference from electrons may exist between taps, for example, some reflected optical signals may enter the taps originally used for obtaining background signals only, and these errors may be permitted, which also falls within the protection scope of this solution. Assuming that after the evaluation, two total charge quantities of the reflected light signals are denoted sequentially (according to the order of receiving the reflected optical signals) as QA and QB, and a total charge quantity including the background light signals is denoted as QO. A three-tap image sensor may have following three possibilities:

(1) QA=Q1, QB=Q2, and QO=Q3;

(2) QA=Q2, QB=Q3, and QO=Q1; and

(3) QA=Q3, QB=Q1 (of a next pulse period Tp), and QO=Q2.

The processing circuit may then calculate a TOF of the optical signal according to the following formula:

$$t = ( \frac{Q B - Q O}{Q A + Q B - 2 Q O} + m ) Th \qquad ( 4 )$$

m in the formula reflects a delay of a tap onto which the reflected optical signal falls for the first time with respect to the first tap, and m is respectively 0, 1, and 2 for the foregoing three cases. That is, if the reflected optical signal first falls onto an n^{th} tap, m=n−1. n refers to a serial number of a tap corresponding to QA, and a phase delay time of the tap whose serial number is n relative to a transmitted optical pulse signal is (n−1)×Th; and j refers to that the reflected pulse beam is first acquired by a tap in a j^{th} pulse period after the pulse beam is emitted (a pulse period in which a transmitted pulse is located is a 0th pulse period after a to-be-emitted pulse beam is emitted), where Th is a pulse width of a pulse acquisition signal of each tap. Tp is a pulse period, and Tp=N×Th, where N is a quantity of taps participating in pixel electron acquisition.

Comparing formula (4) with formula (3), it can be learned that the measurement distance is extended, and the maximum measurement flight distance is enlarged from c×Th in the conventional method to c×Tp=c×N×Th in this application, where N is the quantity of taps participating in the acquisition of pixel electrons, and a value of N in this example is 3. Therefore, compared with the conventional modulation and demodulation method, this method implements a measurement distance that is three times that of the conventional method through an evaluation mechanism.

The key of the foregoing modulation and demodulation method is how to determine a tap onto which the reflected optical signal falls. In this regard, this application provides the following determination methods.

(1) Single-tap maximization method. Obtain a tap (denoted by Nodeₓ) having a maximum output signal (total charge quantity) by searching from a tap 1 to a tap N (N=3 in the foregoing embodiment) according to a sequence of Node₁→Node₂→ . . . →Node_{N}→Node₁→ . . . , where a previous tap of Node is denoted by Node_{w}, and a next tap of Node is denoted by Node_{y}. If total charge quantities of Node and Node_{y} are Q_{w}≥Q_{y}, Node is a tap A, and if Q_{w}<Q_{y}, Nodeₓ is the tap A.

(2) Adjacent-tap sum maximization method. A sum of total charge quantities of adjacent taps is first calculated according to a sequence Node₁→Node₂→ . . . →Node_{N}→Node₁→ . . . , that is, Sum₁=Q₁+Q₂, Sum₂=Q₂+Q₃, . . . , Sum_{N}=Q_{N}+Q₁. If a maximum sum is found as Sumₙ, a tap n is the tap A, and a next tap of the tap n is the tap B.

After the taps A and B are determined, there are at least four methods for calculating a background signal quantity.

(1) Background after B: taking a signal quantity of a tap after the tap B as the background signal quantity.

(2) Background before A: taking a signal quantity of a tap before the tap A as the background signal quantity.

(3) Average background: taking an average value of signal quantities of all taps except the taps A and B as the background signal quantity.

(4) Average background after being reduced by 1: taking an average value of signal quantities of all taps except the taps A and B and a next tap of the tap B as the background signal quantity.

It should be noted that, when N=3, namely, there are only 3 taps, the method (4) is unworkable, and the methods (1) to (3) are equivalent. When k=4, the methods (3) and (4) are equivalent, and to reduce the interference of the signal quantity as much as possible, the method (3) may be preferred over method (4). When k>4, the method (4) may be preferred over the method (3).

A 3-tap pixel-based modulation and demodulation method is described in the foregoing embodiment. It may be understood that, this modulation and demodulation method is also applicable to a pixel with more taps, namely, N>3. For example, a measurement distance of which a maximum value is 4Th may be implemented for a 4-tap pixel, and a measurement distance of which a maximum value is 5Th may be implemented for a 5-tap pixel. Compared with the conventional PM-iTOF measurement solution, this measurement method expands the longest measurement TOF from the pulse width time Th to the entire pulse period Tp, which is referred to as a single-frequency full-period measurement solution herein.

The foregoing modulation and demodulation method increases the measurement distance by (N−1) times, but still cannot implement measurement with a longer distance. For example, according to the 3-tap pixel-based modulation and demodulation method, when a TOF corresponding to a distance to the object exceeds 3Th, the reflected optical signal in one pulse period Tp may first fall onto a tap of a subsequent pulse period. In this case, the TOF or the distance cannot be measured accurately by using formula (3) or formula (4). For example, when the reflected optical signal in one pulse period Tp first falls onto an n^{th} tap in a subsequent j^{th} pulse period, a TOF of a real object corresponding to the optical signal is shown in the following formula:

$$t = ( \frac{Q B - QO}{Q A + Q B - 2 QO} + m ) Th + j \cdot Tp \qquad ( 5 )$$

where m=n−1, and n is a serial number of a tap corresponding to QA. The total charge quantity of each tap is obtained by integrating charges accumulated in related pulse periods, so that a specific value of j cannot be recognized only from the outputted total charge quantity of each tap, leading to a confusion of distance measurement.

FIG. 3 is a schematic diagram of optical signal transmission and acquisition for a time-of-flight depth camera, according to another embodiment of this application, which may be used for resolving the foregoing confusion problem. Different from the embodiment shown in FIG. 2, this embodiment adopts a multi-frequency modulation and demodulation method, namely, different modulation and demodulation frequencies are used in adjacent frames. For ease of description, in this embodiment, two adjacent frame periods are used as an example for description. In adjacent frame periods, K is a quantity of times that a pulse is transmitted, K may equal to 2 (or more and may vary due to different quantities of frames), N is a quantity of taps of a pixel, N may equal to 3, pulse periods Tpi are Tp1 and Tp2 respectively, pulse widths Thi are Th1 and Th2 respectively, and charges accumulated by the three taps of each pulse are q11, q12, q21, q22, q31, and q32, respectively, and total charge quantities may be obtained as Q11, Q12, Q21, Q22, Q31, and Q32 according to formula (2).

It is assumed that a distance to an object in adjacent frame (or a plurality of consecutive frame) periods is not changed, so that tin the adjacent frame periods is the same. After the total charge quantities of the taps are received, the processing circuit uses the modulation and demodulation method shown in FIG. 2 to measure the distance d (or t) in each frame period, and calculates QAi, QBi, and QOi in each frame period according to the foregoing determination method, where i represents an i^{th} frame period, and i is equal to 1 or 2 in this embodiment. To enlarge a measurement range, the reflected optical signal is permitted to fall onto a tap in a subsequent pulse period. If a reflected optical signal on one pixel in an i^{th} frame period first falls onto an mi^{th} tap in a ji^{th} pulse period after a pulse period in which a transmitted pulse is located (the pulse period in which the transmitted pulse is located is a 0^{th} pulse period after a to-be-emitted pulse beam is emitted), a corresponding TOF may be represented according to formula (5) as follows:

$$ti = ( \frac{Q B i - QOi}{Q A i + Q B i - 2 QOi} + mi ) Thi + ji \cdot Tpi \qquad ( 6 )$$

Considering that the distance to the object in adjacent frame periods is not changed, the following formula is established for a case of two consecutive frames in this embodiment:

(x1+m1)Th1+j1·Tp1=(x2+m2)Th2+j2·Tp2 (7)

where

$$x i = \frac{Q B i - Q O i}{Q A i + Q B i - 2 Q O i} ,$$

and i is equal to 1 or 2.

The following formula is established for a case of a plurality of consecutive frames (assuming that there are w consecutive frames, where i is equal to 1, 2, . . . , or w):

(x1+m1)Th1+j1·Tp1=(x2+m2)Th2+j2·Tp2= . . . =xw+mwThw+jw·Tpw (8)

It may be understood that, when w=1, this case corresponds to the single-frequency full-period measurement solution described above. When w>1, a ji combination with a minimum ti variance in modulation and demodulation frequencies may be found, according to the remainder theorem or by traversing all ji combinations within a maximum measurement distance, as a solution value to complete the solution on ji. Then weighted averaging is performed on TOFs or measured distances that are solved under each group of frequencies to obtain a final TOF or measured distance. By using a multi-frequency modulation and demodulation method, a maximum measurement TOF is extended to:

tₘₐₓ=LCM(Tp₁,Tp₂, . . . ,Tp_{w}) (9)

A maximum measurement flight distance is extended to:

Dₘₐₓ=LCM(Dₘₐₓ₁,Dₘₐₓ₂, . . . ,D_{maxw}) (10)

where Dmaxᵢ=C·Tpᵢ, and LCM represents obtaining a “lowest common multiple” (the ‘lowest common multiple’ herein is a general expansion of a lowest common multiple in an integer domain, and LCM(a, b) is defined as a minimum real number that is divisible by real numbers a and b).

It is assumed that in the embodiment shown in FIG. 3, if Tp=15 ns, the maximum measurement flight distance is 4.5 meters (m), and if Tp=20 ns, the maximum measurement flight distance is 6 m. If the multi-frequency modulation and demodulation method is used, for example, in an embodiment, Tp1=15 ns and Tp2=20 ns, a lowest common multiple of 15 ns and 20 ns is 60 ns, a maximum measurement distance corresponding to 60 ns is 18 m, and a corresponding longest measurement target distance may reach 9 m.

It may be understood that, although in the embodiment shown in FIG. 3, a distance to the object is calculated according to data of at least two frames. In another embodiment, a two-consecutive-frame postponement manner may be used to avoid reduction of a quantity of frames to be acquired. For example, for a case of performing measurement according to two consecutive frames in a double-frequency modulation and demodulation method to obtain a single TOF, a first TOF is calculated according to the first and second frames, a second TOF is calculated according to the second and third frames, and so on, thereby not reducing a measurement frame rate.

It may be understood that, in the foregoing multi-frequency modulation and demodulation method, different measurement scenario requirements may be met by using different frequency combinations. For example, the accuracy of the final distance analysis may be improved by increasing a quantity of measurement frequencies. To dynamically meet measurement requirements in different measurement scenarios, in an embodiment of this application, the processing circuit adaptively adjusts the quantity of modulation and demodulation frequencies and a specific frequency combination according to feedback of results, to meet requirements in different measurement scenarios as much as possible. For example, in an embodiment, after a current distance to the object (or a TOF) is calculated, the processing circuit collects statistics on target distances. When most measurement target distances are relatively close, a relatively small quantity of frequencies may be used for measurement to ensure a relatively high frame frequency and to reduce the effect of the target movement on a measurement result. When there is a relatively large quantity of long-distance targets among the measurement targets, the quantity of measurement frequencies may be properly increased, or a measurement frequency combination may be properly adjusted to ensure the measurement precision.

In addition, for the method described in this application and content described in the embodiments, it should be noted that, for any three-tap or more-tap sensor-based multi-frequency long distance or single-frequency full-period measurement solution, regardless of whether a waveform of a modulation and demodulation signal within an exposure time range is continuous or discontinuous, fine adjustment on both a measurement sequence of modulation and demodulation signals with different frequencies and modulation frequencies in the same exposure time shall fall within the protection scope of this application. Any description or analysis algorithm performed for explaining the principle of this application is only an instance description of this application and should not be considered as a limitation on the content of this application. A person skilled in the art, to which this application belongs, may further make some equivalent replacements or obvious variations without departing from the concept of this application. Performance or functions of the replacements or variations are the same as those in this application, and all the replacements or variations should be considered as falling within the protection scope of this application.

The time-of-flight depth camera in the foregoing embodiments needs to actively emit light due to being based on the iTOF technology. When a plurality of iTOF depth cameras close to each other work simultaneously, an acquisition module of a device may not only receive an optical signal that is from a light emitting unit of the device and reflected by an object, but also receive emitted light or reflected light from other devices. The optical signals from the other devices may interfere with quantities of electrons acquired by taps, and further have an adverse effect on the accuracy and precision of final target distance measurement. For this problem, this application provides the following manners to eliminate coherent interference among a plurality of devices:

(1) Frequency conversion solution. The frequency conversion solution refers to that, in an actual measurement process, when a frequency of a modulation and demodulation signal is set to fₘ₀, a frequency of a modulation and demodulation signal that is actually used is fₘ=fₘ₀+Δf, where Δf is a random frequency deviation. According to this manner, at least one random deviation exists among operating frequencies of stand-alone devices, thereby significantly reducing the mutual interference among the devices.

(2) Random exposure time. Compared with the entire working time, an exposure time of a camera is relatively limited. A double-frequency solution is used as an example, two exposures are required at most for obtaining data of each depth frame, and when a single exposure time is 1 ms and a frame rate of the depth frame is 30 fps, a ratio of the exposure time to the entire working time is only 6%. Selections of the exposure time are generally uniformly distributed within the entire working time. To reduce the mutual interference among the devices, a random deviation may be added based on the uniform distribution of the exposure time. In this way, exposure imaging times of different devices may be staggered as much as possible, to avoid mutual interference. To ensure that time intervals for obtaining images are the same as much as possible, the same time deviation may be used in a relatively long working time period (for example, 1 s), to ensure that image time intervals are the same in this time period.

The beneficial effects achieved by this application include resolving a conflict that the pulse width is in direct proportion to a measurement distance and power consumption, but is inversely correlated with the measurement precision in an existing PM-iTOF measurement solution. Therefore, the extension of the measurement distance is no longer limited by the pulse width, so that relatively low measurement power consumption and relatively high measurement precision may still be achieved for a relatively long measurement distance. Compared with the CW-iTOF measurement solution, in this solution, for a single group of modulation and demodulation frequencies, one frame of depth information may be obtained by outputting signal amounts of three taps through only one exposure, thereby significantly reducing the overall measurement power consumption and improving the measurement frame frequency. Therefore, this solution has apparent advantages over the existing iTOF technical solutions.

The foregoing contents are detailed descriptions of this application with reference to specific embodiments, and it should not be considered that the specific implementation of this application is limited to these descriptions. A person skilled in the art, to which this application belongs, may further make some equivalent replacements or obvious variations without departing from the concept of this application. Performance or functions of the replacements or variations are the same as those in this application, and all the replacements or variations should be considered as falling within the protection scope of this application.

What is claimed is:

1. A time-of-flight depth camera, comprising:
a light source for emitting a pulse beam to an object to be measured;
an image sensor comprising at least one pixel, wherein each of the at least one pixel comprises a plurality of taps, and each of the plurality of taps is used for acquiring a charge signal based on a reflected pulse beam due to the pulse beam reflected from the object to be measured or a charge signal of background light; and
a processing circuit configured to control the light source to emit pulse beams of different frequencies in adjacent frame periods,
receive charge signals of the plurality of taps in the adjacent frame periods respectively, determine whether the charge signals comprise the charge signal of the reflected pulse beam, and
calculate a time of flight of the pulse beam and/or a distance to the object to be measured according to a result of the determining.

2. The time-of-flight depth camera according to claim 1, wherein the processing circuit calculates the time of flight of the pulse beam according to the following formula:
$$t = ( \frac{Q B - Q O}{Q A + Q B - 2 Q O} + m ) T h + j \cdot Tp$$
wherein, after the determining, QA is a charge quantity comprising the charge signal of the reflected pulse beam and acquired by a first one of the plurality of taps; QB is a charge quantity comprising the charge signal of the reflected pulse beam and acquired by a second one of the plurality of taps; QO is a charge quantity comprising the charge signal of the background light and acquired by the plurality of taps; m=n−1, wherein n refers to a serial number of a tap corresponding to the QA; j refers to that the reflected pulse beam is first acquired by a tap in a j^{th} pulse period after the pulse beam is emitted; Th is a pulse width of a pulse acquisition signal of each tap; and Tp is a pulse period.

3. The time-of-flight depth camera according to claim 2, wherein:
the determining comprises a single-tap maximization method, to obtain a first tap with a maximum charge quantity of charge signals in the plurality of taps, and if a charge quantity of charge signals of a second tap before the first tap is greater than a charge quantity of charge signals of a third tap after the first tap, the charge quantity of charge signals acquired by the second tap is the QA and a charge quantity of charge signals acquired by the first tap is the QB; and if the charge quantity of the charge signals of the second tap before the first tap is less than the charge quantity of the charge signals of the third tap after the first tap, the charge quantity of the charge signals acquired by the first tap is the QA and the charge quantity of the charge signals of the third tap is the QB; or
the determining comprises an adjacent-tap-sum maximization method, to obtain a maximum sum of charge quantity of charge signals after calculating a charge quantity of charge signals of adjacent taps, wherein charge quantities of charge signals acquired by two taps corresponding to the maximum sum are respectively the QA and the QB according to a serial number sequence of the two taps.

4. The time-of-flight depth camera according to claim 2, wherein a value of j is obtained (i) according to a remainder theorem or (ii) by traversing values of j corresponding to frame periods within a maximum measurement distance, and using a value of j with a minimum time of flight calculation variance as a solution value.

5. The time-of-flight depth camera according to claim 2, wherein the QO is obtained by at least one of the following manners:
taking a charge quantity of charge signals acquired by a tap after a tap corresponding to the QB; taking a charge quantity of charge signals acquired by a tap before the tap corresponding to the QA;
taking an average value of charge quantities of charge signals acquired by the plurality of taps excluding the tap corresponding to the QA and the tap corresponding to the QB; or
taking an average value of charge quantities of charge signals acquired by the plurality of taps excluding the tap corresponding to the QA and the tap corresponding to the QB and a tap after the tap corresponding to the QB.

6. A distance measurement method, comprising:
emitting, by a light source, a pulse beam to an object to be measured;
acquiring, by an image sensor comprising at least one pixel, a charge signal based on a reflected pulse beam due to the pulse beam reflected from the object to be measured or a charge signal of background light, wherein each of the at least one pixel comprises a plurality of taps, and each of the plurality of taps is used for acquiring the charge signal;
controlling the light source to emit pulse beams of different frequencies in adjacent frame periods, and receiving charge signals of the plurality of taps in the adjacent frame periods respectively;
determining whether the charge signals comprise the charge signal of the reflected pulse beam; and
calculating a time of flight of the pulse beam and/or a distance to the object to be measured according to a result of the determining.

7. The distance measurement method according to claim 6, wherein the time of flight is calculated according to the following formula:
$$t = ( \frac{Q B - Q O}{Q A + Q B - 2 Q O} + m ) T h + j \cdot Tp$$
wherein, after the determining, QA is a charge quantity comprising the charge signal of the reflected pulse beam and acquired by a first one of the plurality of taps; QB is a charge quantity comprising the charge signal of the reflected pulse beam and acquired by a second one of the plurality of taps; QO is a charge quantity only comprising the charge signal of the background light and acquired by the plurality of taps; m=n−1, wherein n refers to a serial number of a tap corresponding to the QA; j refers to that the reflected pulse beam is first acquired by a tap in a j^{th} pulse period after the pulse beam is emitted; Th is a pulse width of a pulse acquisition signal of each tap; and Tp is a pulse period.

8. The distance measurement method according to claim 7, wherein:
the determining comprises a single-tap maximization method, to obtain a first tap with a maximum charge quantity of charge signals in the plurality of taps, and if a charge quantity of charge signals of a second tap before the first tap is greater than a charge quantity of charge signals of a third tap after the first tap, the charge quantity of charge signals acquired by the second tap is QA and a charge quantity of charge signals acquired by the first tap is the QB; and if the charge quantity of the charge signals of the second tap before the first tap is less than the charge quantity of the charge signals of the third tap after the first tap, the charge quantity of the charge signals acquired by the first tap is the QA and the charge quantity of the charge signals of the third tap is the QB; or
the determining comprises an adjacent-tap-sum maximization method, to obtain a maximum sum of charge quantity of charge signals after calculating a charge quantity of charge signals of adjacent taps sequentially, wherein charge quantities of charge signals acquired by two taps corresponding to the maximum sum are respectively the QA and the QB according to a serial number sequence of the two taps.

9. The distance measurement method according to claim 7, wherein a value of j is obtained (i) according to a remainder theorem or (ii) by traversing values of j corresponding to frame periods within a maximum measurement distance, and using a value of j with a minimum time of flight calculation variance as a solution value.

10. The distance measurement method according to claim 7, wherein the QO is obtained by at least one of the following manners:
taking a charge quantity of charge signals acquired by a tap after a tap corresponding to the QB; taking a charge quantity of charge signals acquired by a tap before the tap corresponding to the QA;
taking an average value of charge quantities of charge signals acquired by the plurality of taps excluding the tap corresponding to the QA and the tap corresponding to the QB; or
taking an average value of charge quantities of charge signals acquired by the plurality of taps excluding the tap corresponding to the QA and the tap corresponding to the QB and a tap after the tap corresponding to the QB.
